(19) United States
(12) Patent Application Publication
(10) Pub. No.: US 2010/0306057 A1
(43) Pub. Date: Dec. 2, 2010

(54) METHOD AND APPARATUS FOR PROVIDING ACTIONABLE OBJECTS DURING PERIODS OF NETWORK UNAVAILABILITY

(75) Inventors: Serge Rene Haumont, Helsinki (FI); Ronan Mac Laverty, Helsinki (FI)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/474,853

(22) Filed: May 29, 2009

(51) Int. Cl. G06Q 30/00; G06F 3/048

(52) U.S. Cl. 705/14.55; 715/810

(57) ABSTRACT

An approach is provided for the presentation of an actionable object on a mobile device. A presentation of an actionable object is initiated on a mobile device. The actionable object invokes an action. An input from a user specifying selection of the actionable object is received. Whether the mobile device is able to complete the action is determined. If the mobile device cannot complete the action, the action is substituted with an alternative action relating to the actionable object.

### BACKGROUND

Wireless (e.g., cellular) service providers and device manufacturers are continually challenged to deliver value and convenience to consumers by, for example, providing compelling network services, applications, and content, as well as user-friendly devices. Important differentiators in this industry are application and network services. In particular, these services can include advertising. Traditionally, little effort has been directed towards mobile advertising or advertising schemes associated with different stages of network access.

### Some Example Embodiments

According to one embodiment, a method comprises initiating presentation of an actionable object on a mobile device, wherein the actionable object invokes an action. The method also comprises receiving an input from a user specifying selection of the actionable object; determining whether the mobile device is able to complete the action; and substituting, if the mobile device is unable to complete the action, the action with an alternative action relating to the actionable advertisement object.

According to another embodiment, an apparatus comprising at least one processor, and at least one memory including computer program code, the at least one memory and the computer program code configured to, with the at least one processor, cause the apparatus to initiate presentation of an actionable object on a mobile device, wherein the advertisement object invokes an action. The apparatus is also caused to receive an input from a user specifying selection of the actionable object. The apparatus is further caused to determine whether the mobile device is able to complete the action, and substitute, if the mobile device is unable to complete the action, the action with an alternative action relating to the actionable object.

According to another embodiment, a computer-readable storage medium carrying one or more sequences of one or more instructions which, when executed by one or more processors, cause an apparatus to initiate presentation of an actionable object on a mobile device, wherein the advertisement object invokes an action. The apparatus is also caused to receive an input from a user specifying selection of the actionable object, determine whether the mobile device is able to complete the action, and substitute, if the mobile device is unable to complete the action, the action with an alternative action relating to the actionable object.

According to yet another embodiment, an apparatus comprises means for initiating presentation of an actionable object on a mobile device, wherein the actionable object invokes an action. The apparatus also comprises means for receiving an input from a user specifying selection of the actionable object, means for determining whether the mobile device is able to complete the action, and means for substituting, if the mobile device is unable to complete the action, the action with an alternative action relating to the actionable object.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of performing alternate out-of-service advertisement actions, according to one embodiment;

FIG. 2 is a diagram of the components of user equipment, according to one embodiment;

FIG. 3 is a flowchart of a process for providing advertising actions, according to one embodiment;

FIG. 4 is a flowchart of a process for providing alternative advertising actions for out-of-service user equipments, according to one embodiment;

FIG. 5-7 are a diagrams of user interfaces utilized in the processes of FIG. 3, according to various embodiments;

FIG. 8 is a diagram of hardware that can be used to implement an embodiment of the invention;

FIG. 9 is a diagram of a chip set that can be used to implement an embodiment of the invention; and

FIG. 10 is a diagram of a mobile station (e.g., handset) that can be used to implement an embodiment of the invention.

### DESCRIPTION OF PREFERRED EMBODIMENT

A method, software, and apparatus for actionable objects during periods of network unavailability are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to advertisements on mobile devices, it is contemplated that the approach described herein may be used with other content and devices.

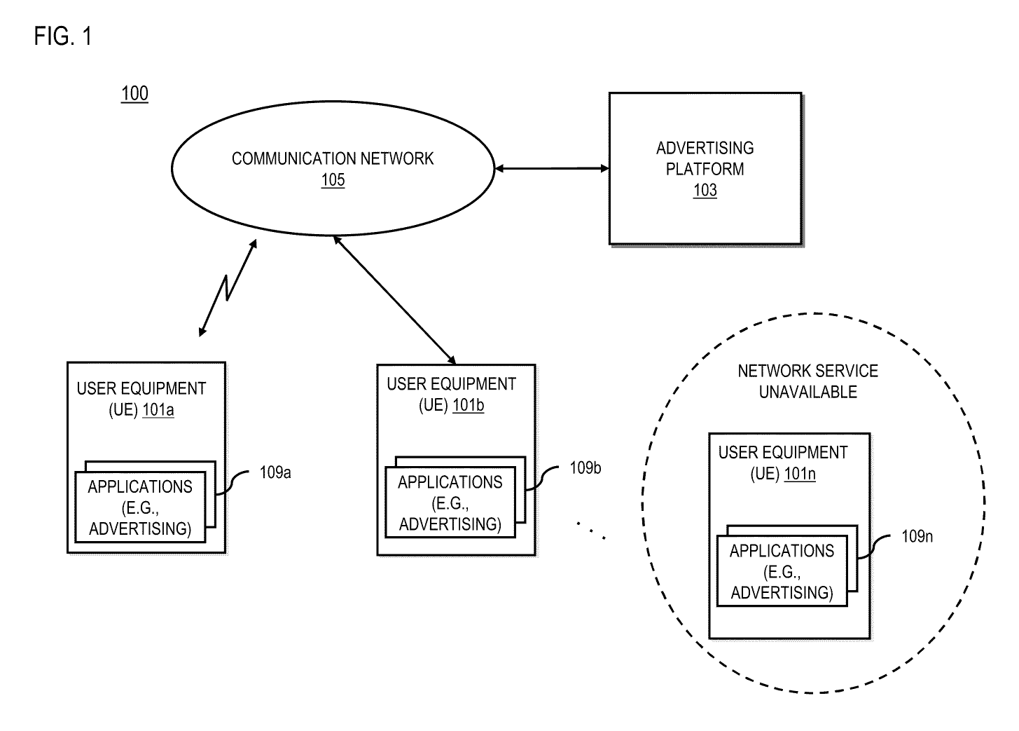

FIG. 1 is a diagram of a system 100 capable of performing alternate out-of-service advertisement actions, according to one embodiment. For purposes of illustration, system 100 provides for the management of advertisements on user equipment. It is noted that certain “click to” actions (e.g., “click to call,” “click to landing page,” “click to e-mail,” “click to map location,” and “click to purchase”) do not function properly on a user equipment when the user equipment has no network service. Thus, the system 100 is capable of performing alternate “click to” actions (e.g. “click to save contact,” “click to bookmark,” “click to queue e-mail,” “click to save map location,” and “click to save purchase item”) in the case where the user equipment is without network service. In certain embodiments, an actionable object or actionable advertisement object refers to an object (e.g., text, image, etc.) that can invoke an action that may require network connectivity to perform the action. For example, the action can be associated with a uniform resource locator (URL), whereby the user can be provided with content; in general, unless the content is locally cached, the content is retrieved from a repository accessible via network service. In the context of advertising, such action can specify initiating communication with the advertiser, presentation of an offer or promotion, etc.

As shown in FIG. 1, system 100 comprises one or more user equipment (UEs), e.g., UEs 101a-101n, having connectivity to an advertising platform 103 via a communication network 105. The advertising platform 103 can provide advertising content, including actionable advertising content, to a user via an application 109a-109b on a ULE 101a-101b. Additionally, the advertising application 109n can cache advertising content, including actionable advertising content, to be available to a UE 101n that is out-of-service. In one embodiment, a UE 101 provides different user interfaces depending on whether the UE 101 has network service—e.g., within or outside service range. It is noted that network availability and access can also be dictated by other factors, such as low-power condition of the UE 101, network equipment failure, or environmental conditions (such as heavy rain).

In one embodiment, the advertising platform 103 is an ad server that updates UEs 101 with updated advertising content. The UEs 101 can be in-service 101a-101b or out-of-service 101n. The advertising platform 103 updates the UEs 101 while the UEs 101 are in-service either periodically, or at the occurrence of an event. Such an event can include a UE 101 returning to a service area.

In one embodiment, the UE 101 has an embedded ad server. The embedded ad server can contact the advertising platform 103 to receive advertising updates. An application 109 on the UE 101 can request and display an ad unit from the embedded ad server. The ad unit can contain “click to” actions that require network connectivity to be fulfilled. If the action cannot be fulfilled, the embedded ad server can collect necessary information and save the request until network connectivity is returned.

As shown in FIG. 1, the system 100 comprises a user equipment (UE) 101 having connectivity to advertising platform via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), the Internet, or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, mobile ad-hoc network (MANET), and the like.

The UE 101 is any type of mobile terminal, fixed terminal, or portable terminal including a mobile handset, station, unit, device, multimedia tablet, Internet node, communicator, desktop computer, laptop computer, Personal Digital Assistants (PDAs), or any combination thereof. Under this scenario, the UE 101a employs a radio link to access network 105, while connectivity of UE 101b to the network 105 can be provided over wired link, and some UEs 101n are in an out-of-service area. It is also contemplated that the UE 101 can support any type of interface to the user (such as “wearable” circuitry, etc.).

By way of example, the UE 101 and advertising platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

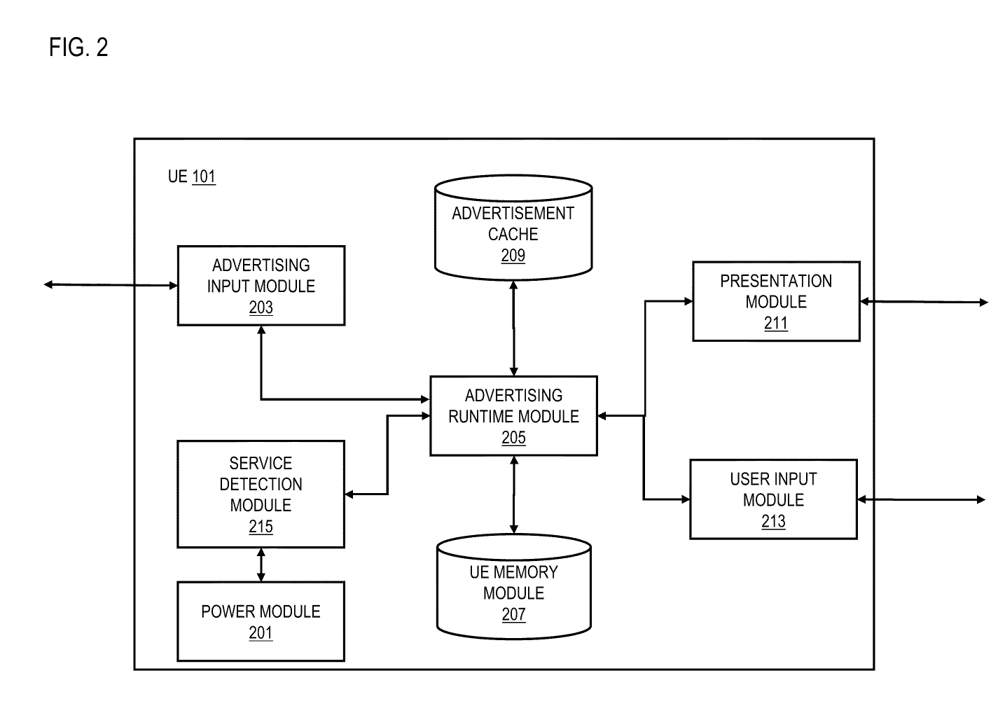

FIG. 2 is a diagram of the components of user equipment 101, according to one embodiment. By way of example, the UE 101 includes one or more components for providing out-of-service advertising alternatives. It is contemplated that the functions of these components may be combined in one or more components or performed by other components of equivalent functionality. In this embodiment, the UE 101 includes a power module 201 to power the UE 101. The power module can be any include any type of power source, including battery, plug-in, etc.

In one embodiment, the UE 101 includes an advertising input module 203. The advertising input module 203 can request and receive advertisement updates from an advertising platform 103 periodically or due to an event. These updates can be customized for time, location, and user preferences. For example, a user interested in sporting goods can receive advertisements more customized to sporting goods while users interested in restaurants can receive advertisements more customized to food and drinks. Additionally, the advertisements can be customized to time and location (e.g. dinner specials in a user's vicinity).

In one embodiment, the UE 101 includes an advertising runtime module 205 that can be run in a UE memory 207. This receives advertising input from the advertising input module 203 and stores the advertising input in a local advertisement cache 209. The advertisement cache 209 can include creative advertising data (e.g., an icon, background image, or sound) as well as actionable “click to” ad data leading to contact information (e.g., phone numbers, uniform resource locator (URL), short message service (SMS), etc.). This information can be saved as metadata in the advertisement. The advertising runtime module 205 can display advertisements to a user via a presentation module 211. The presentation module 211 can present an image, sound, text, video, etc. The presentation module 211 can also display actionable buttons like “click to see website” and “click to call” with contact information. A user can select an action via a user input module 213 on the UE 101 (e.g. clicking a button, using a mouse, or clicking a touch-screen).

In one embodiment, the advertising runtime module 205 can detect if a UE 101 is within service range of a service network via a service detection module 215. The service detection module 215 can detect if the UE 101 has regular service network connectivity, busy network service, busy user line, low network connectivity, or no network connectivity, as well as finer connectivity levels. In this manner, the service detection module 215 can determine data rate degradation in a coverage area. It is noted that network access can be dictated by the service detection module's data rate levels as well as other factors, such as low-power condition of the UE 101, network equipment failure, environmental conditions, or the called party being busy, not answering, or the network being congested. The service detection module 215 can also detect the battery life of the UE 101 by interfacing with the power module 201. Thus, the service detection module 215 is able to calculate the connection and power capacities of the UE 101 and determine prudent connection decisions. For example, if battery life is low and a high-power network connection is needed, the service detection module 215 can decide that there is an inadequate signal to process a request. A weaker network signal strength can require more power to process and send/receive network messages. Thus, if a battery power level, transmission power level, or signal strength satisfies a predetermined threshold, the action can be completed.

In one embodiment, the advertising runtime module 205 can process user advertising actions. In one embodiment, the advertising runtime module 205 can receive an actionable request from a user input module 213 and request network availability information from the service detection module 215 before attempting to connect to the network. If the service detection module 215 responds that there is sufficient coverage, for example, the advertising runtime module 205 can process the request. If the service detection module 215 responds that there is insufficient coverage or power, the advertising runtime module 205 can substitute the coverage action with an alternative action. In another embodiment, the advertising runtime module 205 attempts to fulfil an actionable request without querying the service detection module 215. Instead, the advertising runtime module 205 monitors the success of the action. If the action fails (e.g. no coverage, network busy, line busy, insufficient power, etc.), the advertising runtime module 205 processes an alternative action. The advertising runtime module 205 can also monitor if the saved information was later used by the user. The advertising runtime module 205 can later communicate that information to the advertising platform 103 by generating and sending a reporting message specifying information of the tracked action and alternative action.

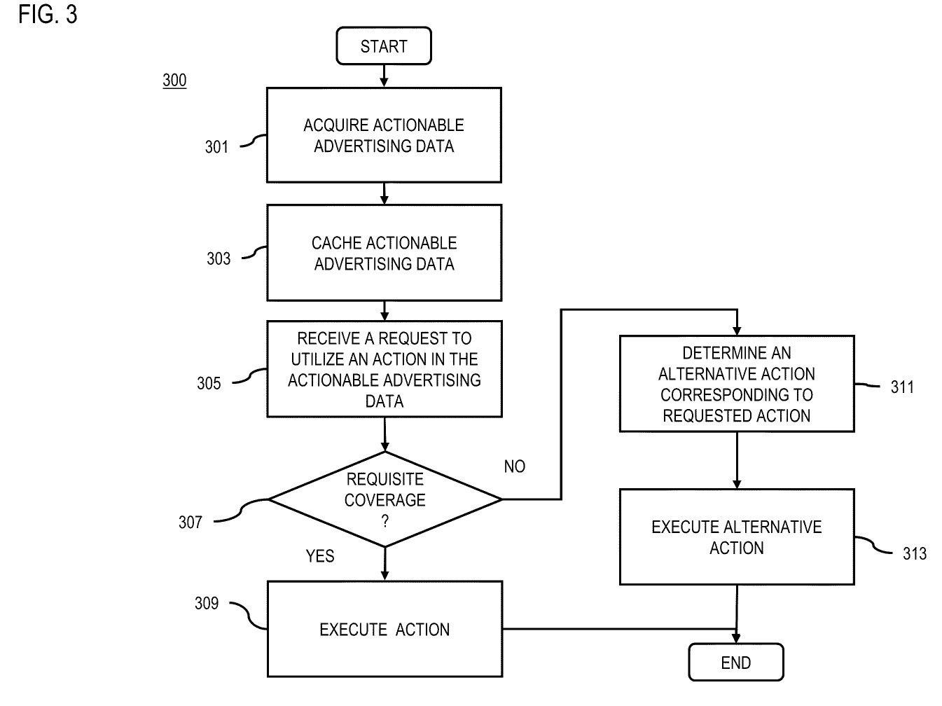

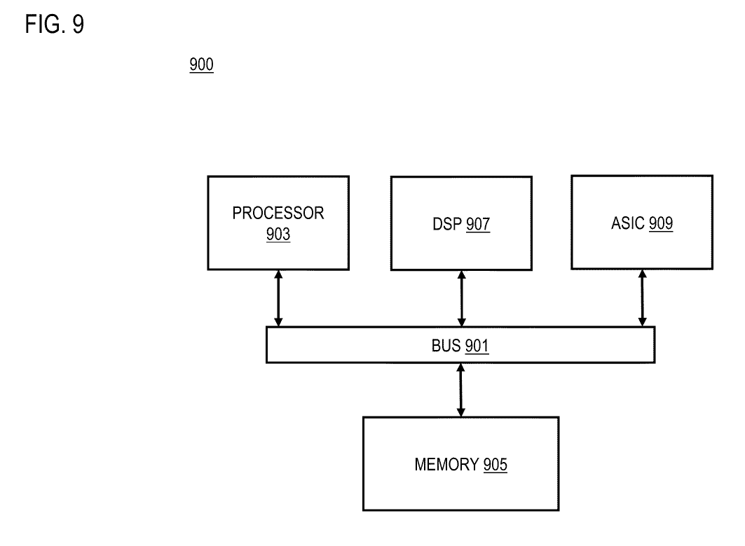

FIG. 3 is a flowchart of a process for providing advertising actions, according to one embodiment. In one embodiment, the advertising runtime module 205 performs the process 300 and is implemented in, for instance, a chip set including a processor and a memory as shown FIG. 9. In step 301, the advertising runtime module 205 acquires advertisement data, including actionable advertising objects or data, from an advertising input module 203. At step 303, the advertising data cached in the advertisement cache 209. The advertising runtime module 205 can then present the advertisement to a user via a presentation module 211 with or without network service. A user can then view the actionable ad and click on an action. Then, at step 305, the advertising runtime module 205 receives a request for an action via a user input module. At step 307, the advertising runtime module 205 determines if there is requisite service and power to complete the action. If there is the necessary coverage, the runtime module 205 executes the action at step 309.

If the UE 101 is in a state that does not have access to a network 311 (e.g., no network service coverage, or otherwise unavailable), the advertising runtime module 205 determines and invokes an alternative action corresponding to the requested action. A “click to website” action can be substituted with a “save to bookmarks” action and a “click to call” action can be replaced by a “save to contacts” action. Additionally, the alternative action can include saving to an “advertisements” list instead of a general bookmark, phone book, or contacts list. Moreover, a “click to e-mail” action can be substituted with a “queue e-mail message.” In one embodiment, a “click to locate” search can be replaced by “queue location information for later presentation.” In another embodiment, a “click to purchase” action is substituted with a “save purchase item” action. Further, an advertising creative (e.g. image or sound) can be saved with the contact or saved information. In certain embodiments, the advertising creative can be provided along with an entry of an electronic phone book or a bookmark. At step 313, the alternative action is executed. In this manner each “click to” action can have an equivalent offline action. When back in coverage, a user can view the contact information. In one embodiment, the UE 101 can notify the user that the action is available when back in service. In another embodiment, the user can select and the UE 101 can initiate a presentation of a contact information list including the advertisement information. The advertising creative (e.g., icon) can be visible to remind the user of the advertisement. Additionally, if the contact information is clicked on from the list, the advertisement can be displayed.

With the above approach, users are able to interface with advertisements to complete actions while in-service and out-of-service. A single transparent action by the user can be used to either perform the action or perform an alternate action corresponding to the in-service action. After the user is back in service, the UE 101 can conveniently notify the user that the action is ready to be performed. Additionally, the above approach can save battery life of a mobile device by selectively attempting to fulfill the action.

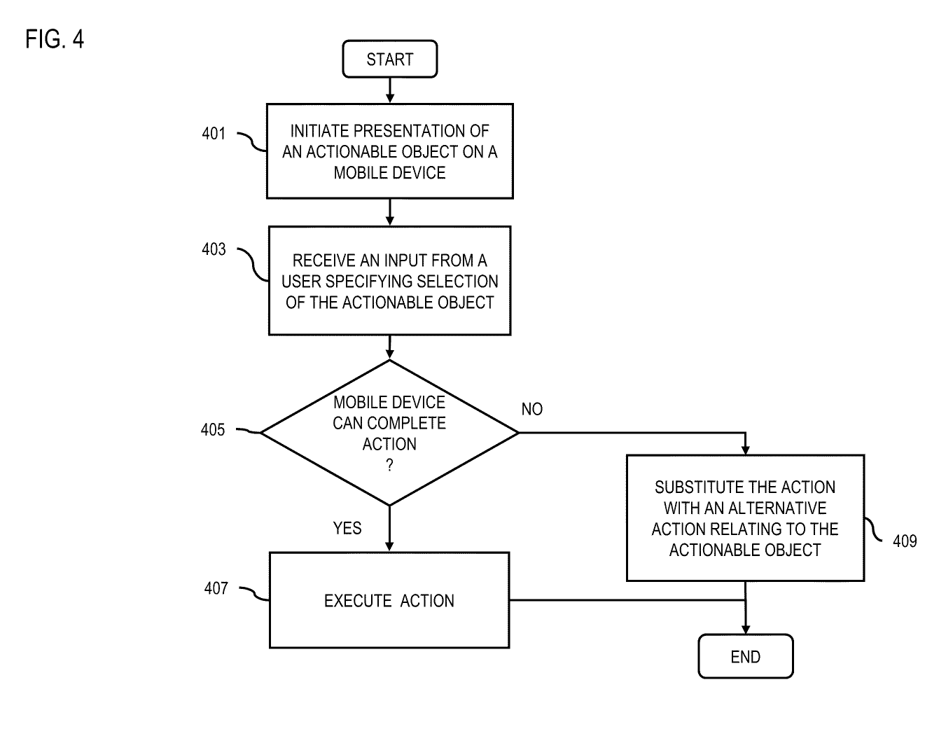

FIG. 4 is a flowchart of a process for providing alternative advertising actions for out-of-service user equipments 101 (e.g. mobile device), according to one embodiment. In one embodiment, the advertising runtime module 205 performs the process 400 and is implemented in, for instance, a chip set including a processor and a memory as shown FIG. 9. In step 401, the mobile device 101 begins a presentation of actionable objects (e.g., actionable advertising objects) that a user can act upon. Such an object can utilize a “click to call,” or “click to visit website” action. At step 403, the user can select an action from the actionable object. Then, at step 405, the advertising runtime module 205 can determine if the mobile device 101 can complete the action (e.g., if access to a network is required, determining whether the mobile device 101 has access to a network). This can be accomplished by querying the service detection module 215 or by attempting the action. If the action can be completed, the action is executed at step 407. If the action cannot be completed (e.g., if there is not requisite access to a required network), an alternative action relating to the actionable object is substituted for the original action, as in step 409.

With the above approach, users are able to complete advertisement actions while out-of-service. The user can view an advertisement and perform an action or perform an alternate action based on network connectivity. If the user is unable to perform the advertisement action due to inadequate network connectivity, the approach conveniently saves the relevant information to allow the user to later complete the action.

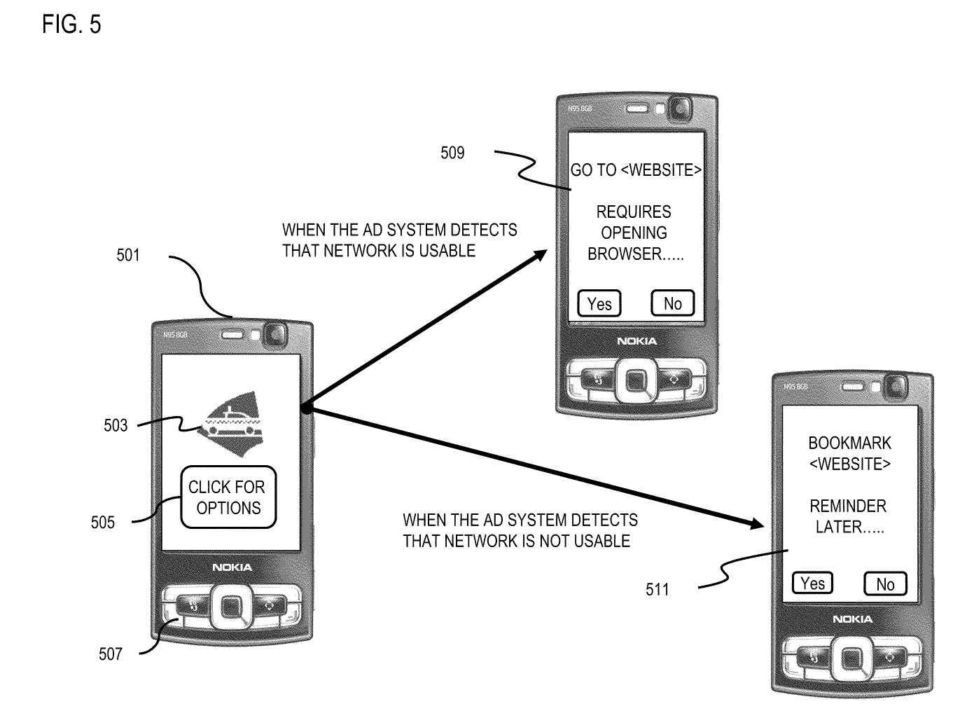

FIG. 5 is a diagram of user interfaces utilized in the processes of FIG. 3 and 4, according to one embodiment. For the purposes of illustration, a ULE 501 is depicted displaying an advertisement for a taxi service to a user. The user views an advertisement creative 503 along with an actionable object 505. The object 505 thus requires network service to execute the action associated with the object 505. The actionable object 505 may be activated in any number of ways. For instance, clicking on a touch-screen action 505 or using a corresponding button 507 can direct a user to an in-service interface 509 or out-of-service interface 511. The in-service interface 509 allows a user to open, for example, a web browser corresponding to the actionable advertisement object. In one embodiment, the out-of-service interface 511 allows the user an option to bookmark the in-service website for future use. The interface 511 also provides the option for the user select to be reminded of the bookmarking action at a later time, when the UE 501 has is able to obtain network service (e.g., within range of network coverage).

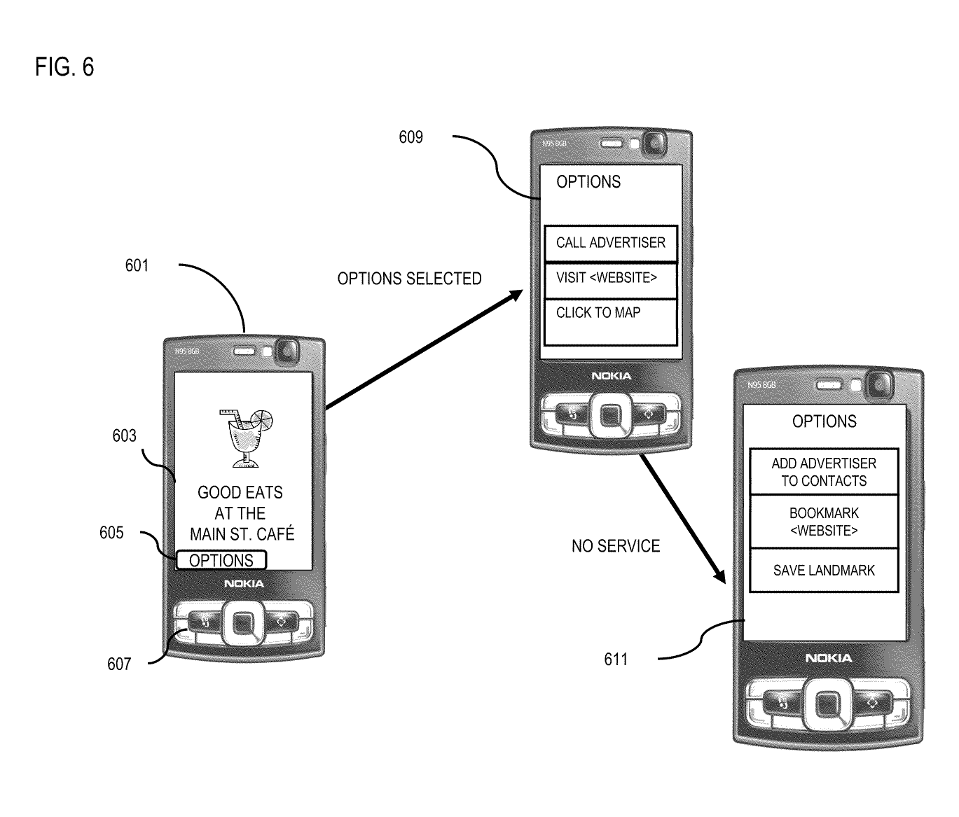

FIG. 6 is a diagram of user interfaces utilized in the processes of FIGS. 3 and 4, according to one embodiment. Initially, UE 601 is shown, for example, presenting an advertisement for a restaurant to a user. The user views an advertisement creative 603 with metadata options 605 that can require network service. Options 605 regarding the actionable media can be selected using a touch-screen interface or by selection buttons 607. Upon activation (i.e., selection) of the options, user interface 609 displays options that can be selected when the UE 601 is in service. By way of example, the user is presented with the following options: call the advertiser, visit the advertiser's website, or map the advertiser's location. The user can select one of those options, and the UE 601 will attempt to connect to the service and complete the action. If the UE 601 is able to connect to the service, the UE 601 will complete the action. If the UE 601 fails to complete the action, the UE 601 via the interface 611 can display out-of-service options for the user to select from. For example, a user can save the location of the restaurant instead of mapping it on a location service such as a global positioning system (GPS) or other navigation service.

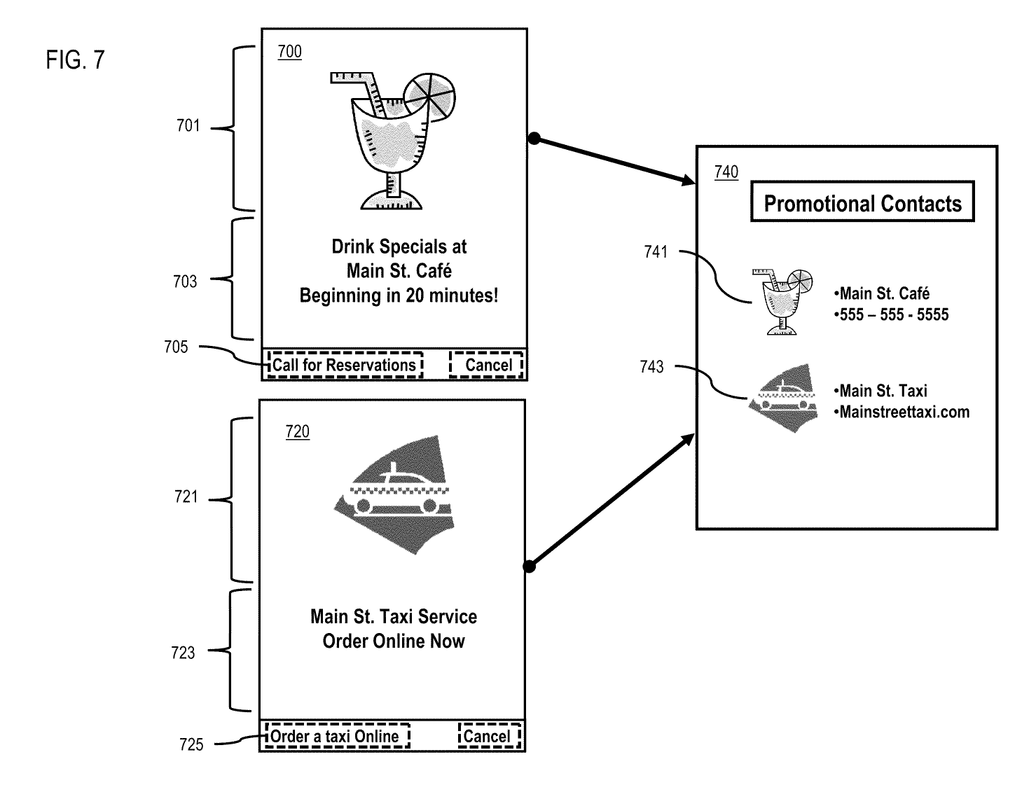

FIG. 7 is a diagram of user interfaces utilized in the processes of FIG. 3 and 4, according to one embodiment. A touch-screen UE interface 700 is shown displaying a restaurant advertisement. The advertisement can include an advertising creative 701 as well as text 703. A user can select an option on the advertisement to call the restaurant. If the UE 101 does not have service, the call is automatically saved to a promotional contacts list. The same touch-screen UE interface 720 can later display a taxi service advertisement. The advertisement may include an advertising creative (e.g. icon) and text 723. The user can select an option to order a taxi online. If the UE 101 is out-of-service range, the website address for the taxi can be automatically saved to a bookmark in a promotional contacts list. Once the UE 101 is back within service range, the user can view a promotional contacts list on a user interface 740. The promotional contacts list displays a Main St. Cafe contact number and icon 741 and a Main Street Taxi URL and icon 743. When in service, the actions can be completed by the user using the promotional contacts interface 740.

The processes described herein for providing actionable advertising services may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

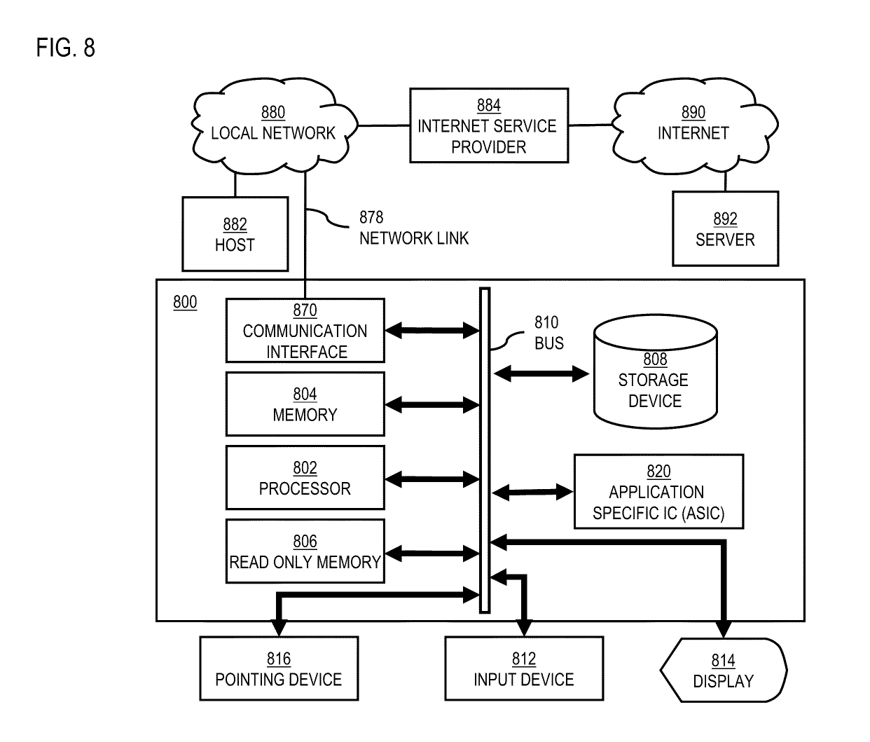

FIG. 8 illustrates a computer system 800 upon which an embodiment of the invention may be implemented. Computer system 800 is programmed (e.g., via computer program code or instructions) to provide actionable advertising services as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to actionable advertising services. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for actionable advertising services. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for actionable advertising services, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection of a UE 101 to the communication network 105 for advertising services.

The term computer-readable medium is used herein to refer to any medium that participates in providing information to processor 802, including instructions for execution. Such a medium may take many forms, including, but not limited to, non-volatile media, volatile media and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

FIG. 9 illustrates a chip set 900 upon which an embodiment of the invention may be implemented. Chip set 900 is programmed to perform actionable advertising services as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to utilize alternative advertisement actions. The memory 905 also stores the data associated with or generated by the execution of the inventive steps.

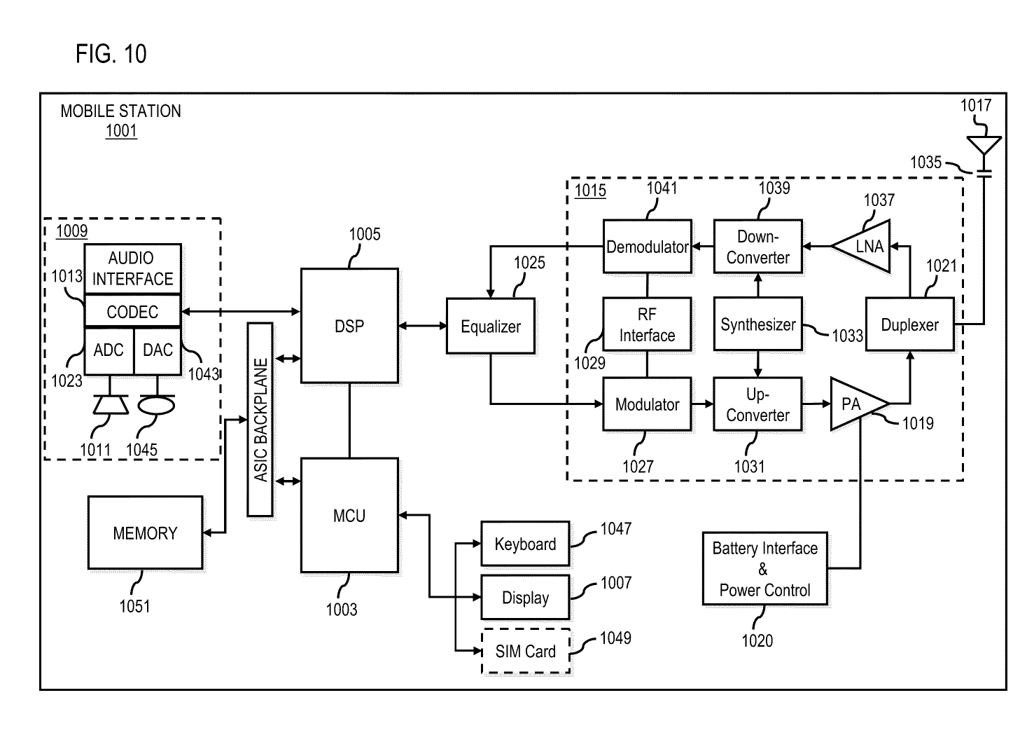

FIG. 10 is a diagram of exemplary components of a mobile station (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions that offer automatic contact matching. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile station 1001 to utilize actionable advertising. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
initiating presentation of an actionable object on a mobile device, wherein the actionable object invokes an action;
receiving an input from a user specifying selection of the actionable object;
determining whether the mobile device is able to complete the action; and
substituting, if the mobile device is unable to complete the action, the action with an alternative action relating to the actionable object.

2. A method of claim 1, wherein the actionable object is an actionable advertisement object and the actionable advertisement object comprises a uniform resource locator (URL), and the alternative action invokes saving the URL as a bookmark.

3. A method of claim 1, wherein the actionable object comprises a telephone number, an e-mail message, a location-based search, or an online purchase, and the alternative action respectively invoke saving the telephone number to a contact list, queuing the e-mail for sending, saving location information, or saving purchase information.

4. A method of claim 1, further comprising:
storing an advertisement creative associated with the actionable object; and
initiating presentation of the advertisement creative.

5. A method of claim 1, further comprising:
invoking the action, if the mobile device can complete the action; and
determining that the action failed, wherein the action is substituted with the alternative action if the action failed.

6. A method of claim 1, wherein the determining step includes:
determining a battery power level, a transmission power level, or a signal strength satisfies a predetermined threshold, wherein the action can be completed if the predetermined threshold is satisfied.

7. A method of claim 1, further comprising:
tracking invocation of the action and the alternative action; and
generating a reporting message specifying information about the tracked invocation of the action and the alternative action.

8. A method of claim 1, wherein the action requires access to a network to be completed.

9. An apparatus comprising:
at least one processor; and
at least one memory including computer program code,
the at least one memory and the computer program code configured to, with the at least one processor, cause the apparatus to perform at least the following,
initiate presentation of an actionable object on a mobile device, wherein the actionable object invokes an action,
receive an input from a user specifying selection of the actionable object,
determine whether the mobile device is able to complete the action, and
substitute, if the mobile device is unable to complete the action, the action with an alternative action relating to the actionable object.

10. An apparatus of claim 9, wherein the actionable object comprises a uniform resource locator (URL), and the alternative action invokes saving the URL as a bookmark.

11. An apparatus of claim 9, wherein the actionable object comprises a telephone number, an e-mail message, a location-based search, or an online purchase, and the alternative action respectively invoke saving the telephone number to a contact list, queuing the e-mail for sending, saving location information, or saving purchase information.

12. An apparatus of claim 9, wherein the apparatus is further caused to:
store an advertisement creative associated with the actionable object, and
initiate presentation of the advertisement creative.

13. An apparatus of claim 9, wherein the apparatus is further caused to:
invoke the action, if the mobile device has access to the network, and
determine that the action failed, wherein the action is substituted with the alternative action if the action failed.

14. An apparatus of claim 9, wherein the determine programming code further causes the apparatus to:
determine a battery power level, a transmission power level, or a signal strength satisfies a predetermined threshold, wherein the action can be completed if the predetermined threshold is satisfied.

15. An apparatus of claim 9, action requires access to a network to be completed.

16. An apparatus of claim 15, wherein the mobile device has no network access, the apparatus is further caused to:
notify the user that the action is available upon obtaining network access.

17. A computer-readable storage medium carrying one or more sequences of one or more instructions which, when executed by one or more processors, cause an apparatus to perform at least the following:
initiate presentation of an actionable object on a mobile device, wherein the actionable object invokes an action;
receive an input from a user specifying selection of the actionable object;
determine whether the mobile device is able to complete the action; and
substitute, if the mobile device is unable to complete the action, the action with an alternative action relating to the actionable object.

18. A computer-readable storage medium of claim 17, wherein the actionable object comprises a telephone number, an e-mail message, a location-based search, or an online purchase, and the alternative action respectively invoke saving the telephone number to a contact list, queuing the e-mail for sending, saving location information, or saving purchase information.

19. A computer-readable storage medium of claim 18, further comprising instructions that cause the apparatus to perform:
store an advertisement creative associated with the actionable object; and
initiate presentation of the advertisement creative.

20. A computer-readable storage medium of claim 18, action requires access to a network to be completed.
